(19) United States
(12) Patent Application Publication
(10) Pub. No.: US 2019/0347616 A1
(43) Pub. Date: Nov. 14, 2019

(54) SYSTEMS AND METHODS FOR TRANSPORT OF CONSTRUCTION MATERIALS

(71) Applicant: EcoDawg, LLC, Alpharetta, GA (US)

(72) Inventor: Michael Bevers, Alpharetta, GA (US)

(21) Appl. No.: 16/406,850

(22) Filed: May 8, 2019

Related U.S. Application Data
(60) Provisional application No. 62/668,938, filed on May 9, 2018.

(51) Int. Cl. G06Q 10/08; G06Q 50/08; G06Q 30/08; G06Q 30/06

(52) U.S. Cl. CPC G06Q 10/08345; G06Q 50/08; G06Q 30/0641; G06Q 30/0639; G06Q 30/08

(57) ABSTRACT

Systems and methods are disclosed for transport of construction materials. In one embodiment, an example method may include determining, by one or more computer processors coupled to at least one memory, a first location of a construction material, receiving at least one image of the construction material, identifying the construction material using the at least one image, determining an amount of the construction material using the at least one image, determining a user identifier of a user interested in the construction material, determining a second location associated with the user identifier, determining a construction service provider identifier for a construction service provider for transport of the construction material from the first location to the second location, and providing an authentication value to the construction service provider for accessing the first location or the second location.

### CROSS-REFERENCE TO RELATED APPLICATION

This application claims the benefit of U.S. Provisional Application No. 62/668,938, filed May 9, 2018, which is incorporated by reference in its entirety.

### FIELD OF THE DISCLOSURE

The present disclosure relates generally to construction materials, and more particularly to facilitating the transport and/or delivery of construction materials.

### BACKGROUND OF THE DISCLOSURE

Construction materials may include materials such as dirt, steel, glass, gravel, wood, brick, stone, interior finishings, and other materials. Some construction materials may be bulky or consume large amounts of space. Some construction materials may be packaged, while other materials, such as dirt, may not be packaged, and as a result, may be delivered to construction sites as loose dirt using dump trucks, for example. Construction materials may be delivered to construction or job sites for use during construction. However, quantities of construction materials that are ordered may be inexact. For example, a contractor may order more construction material than is necessary for a job, so as to avoid shortage in the event some of the material is defective or damaged. After a job is completed, excess construction materials may be at the construction site. In some instances, excess materials may be thrown away or sent to a landfill. However, other contractors or entities, such as those with active job sites, may be interested in the excess construction materials. Accordingly, determining an availability of, and transport or delivery of, construction materials may be desired.

### BRIEF DESCRIPTION OF THE DRAWINGS

FIG. 1 is an example process flow diagram for transport of construction materials in accordance with one or more embodiments of the disclosure.

FIGS. 2-5 schematically illustrate example user interfaces for indicating availability of construction materials in accordance with one or more embodiments of the disclosure.

FIG. 6 schematically illustrates example user interfaces for calculating an amount of available construction material in accordance with one or more embodiments of the disclosure.

FIGS. 7-8 schematically illustrate example user interfaces for a construction material availability and transport platform in accordance with one or more embodiments of the disclosure.

FIG. 9 is an example process flow diagram for transport of construction materials in accordance with one or more embodiments of the disclosure.

FIG. 10 is an example process flow diagram for locating and providing construction tools in accordance with one or more embodiments of the disclosure.

FIG. 11 is an example process flow diagram for authorizing access to various locations in accordance with one or more embodiments of the disclosure.

FIG. 12 schematically illustrates an example computer architecture of a system in accordance with one or more embodiments of the disclosure.

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION OF THE DISCLOSURE

### Overview

Construction materials may be used for construction at construction sites or job sites. Contractors or other entities at construction sites may order supplies and construction materials in excess of job requirements. Upon completion of the job, the excess construction materials and supplies may need to be removed from the site. In some instances, a deadline to clear the site may create a need to remove or dispose of the excess construction materials in a timely manner. In either instance, the construction materials may need to be transported from the job site to another location. However, in many instances the construction materials may be sent to a landfill because the contactor may be unaware of another party that may be interested in the unused and/or excess construction materials, or because the site may need to be cleared in a hurry.

In some instances, such as during performance of grading or excavation work, construction materials such as dirt or gravel may be excavated or otherwise extracted from the site, and may not be of use to the contractor or entity in charge of the construction project. As a result, contractors may desire to remove the construction materials from the site. In some instances, the construction materials may be hauled to a landfill at a cost to the contractor.

Embodiments of the disclosure include systems and methods of locating construction materials, identifying interested users, and facilitating transportation or delivery of the construction materials. Some embodiments may manage or facilitate the transport or delivery of construction materials within certain timeframes. Certain embodiments may coordinate logistics for the short term use and/or services of third party construction tools and/or personnel.

This disclosure relates to, among other things, systems, methods, computer-readable media, techniques, and methodologies for locating construction materials, identifying interested users, and facilitating transportation or delivery of the construction materials. In an example embodiment, one or more servers may receive an indication of a location of construction materials, and amount of the construction materials, a price (if any) of the construction materials, any applicable deadlines, any required authentication, and/or any other ancillary information.

The one or more servers may cause the information to be posted on a platform for the availability and/or exchange of construction materials. The platform may be an electronic web-based or application-based platform and may be configured to match users desiring to find construction materials with other users that have construction materials available. In some instances, users may be local with respect to each other. In some embodiments, the one or more servers may be configured to facilitate the hiring and/or use of third party services for logistical and/or transport of construction materials.

Some embodiments may be configured to implement computer vision based algorithms and/or pattern matching to determine an amount or volume of construction material available using input from one or more cameras or images.

As a result, embodiments of the disclosure may reduce costs associated with excess or unwanted construction materials, and may provide a platform for the matching of users with unwanted construction materials and users that desire such construction materials.

In an example embodiment, an example method that may be executed by, for example, one or more computer processors coupled to at least one memory of one or more remote servers, may include determining a first location of a construction material. For example, a user having excess or unwanted construction material may provide a location of the construction material and one or more images. The method may include receiving at least one image of the construction material. For example, one or more images or videos of the construction material may be uploaded to the one or more servers. The method may include identifying the construction material using the at least one image. For example, using pattern recognition, object recognition, or another image processing algorithm, the construction material may be identified in the at least one image as, for example, sand, dirt, gravel, wood, steel, aluminum, and so forth. The location may be determined using metadata associated with the at least one image. The method may include determining an amount of the construction material using the at least one image. For example, one or more images or a video of the construction material may be used to calculate dimensions, an amount, and/or a volume of a construction material available at a location. The method may include determining a user identifier of a user interested in the construction material. For example, a user may view the at least one image and indicate that the user is interested in the construction material but does not have transport equipment. The method may include determining a second location associated with the user identifier, such as a delivery location for the construction material. The method may include determining a construction service provider identifier for a construction service provider for transport of the construction material from the first location to the second location. For example, a third party transport service may be identified and/or selected for transport of the delivery.

In some embodiments, an auction process may be used to select the transport service. The method may include providing an authentication value to the construction service provider for accessing the first location or the second location. For example, a barcode may be sent to a device associated with the service provider that can be used for verification or authentication to access the first location and/or second location to complete the pickup or drop off of the construction materials. The authentication value may be sent to any of the parties in the event the transport service is not used and the parties would like to complete the transport themselves. The authentication value may be a machine readable image, a code, a passphrase, a graphic, or another value. In some embodiments, the users may be limited in viewing construction materials available nearby. For example, the method may include determining that the second location is within a threshold distance of the first location. After the transport is complete, the method may include determining that the construction material has been transported, and facilitating transfer of an electronic currency from a user account associated with the user identifier. For example, a bank or credit card payment, cryptocurrency payment, or another electronic currency payment or transaction may be facilitated.

### Illustrative Processes and Use Cases

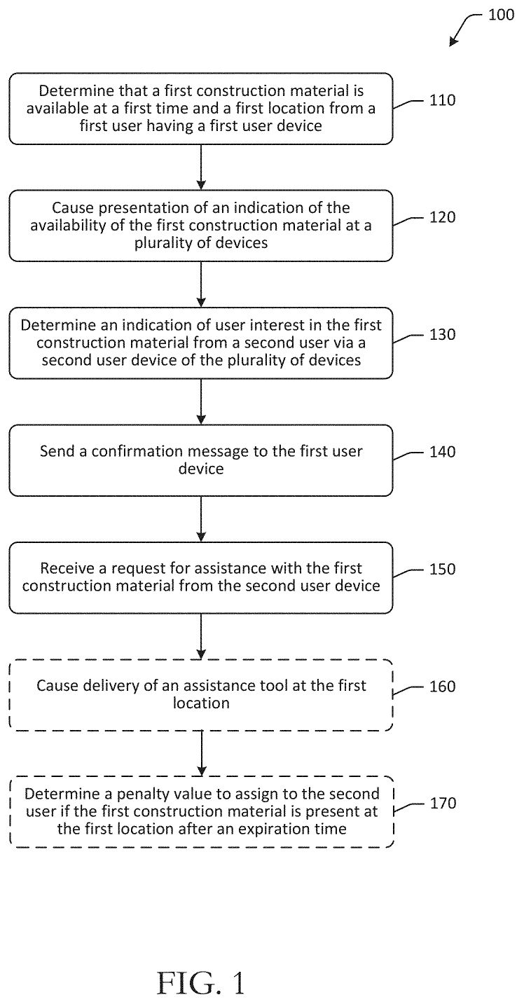

FIG. 1 is an example process flow diagram 100 for transport of construction materials in accordance with one or more embodiments of the disclosure. Although certain operations are illustrated as occurring separately in FIG. 1, some or all of the operations may occur concurrently or partially concurrently. In some embodiments, the operations of the process flow 300 may be executed by one or more processor(s), such as processor(s) of one or more remote servers.

At block 110 of the process flow, it may be determined that a first construction material is available at a first time and a first location from a first user having a first user device. For example, computer-executable instructions of one or more modules at a remote server may be executed to determine that a first construction material, such as dirt or gravel, is available at a certain date and/or time and at a first location from a certain user. For example, the first user may indicate availability of the first construction material at a certain location (which may be automatically determined using a device location or image metadata). The first construction material may be immediately available. A deadline by which the first construction material must be transported may be provided in some instances. The first user may capture one or more images or videos of the first construction material for upload to an electronic platform. In some instances, a price or cost of the first construction material may be included.

At block 120 of the process flow, presentation of an indication of the availability of the first construction material may be caused at a plurality of devices. For example, computer-executable instructions of one or more modules at a remote server may be executed to publish the indication of availability of the first construction material, such as at a webpage or application interface. In some embodiments, a notification or alert may be sent to user devices within a certain distance of the first location, and/or to user devices of users that have previously indicated interest in the first construction material or a type of construction material. In some embodiments, the presentation of the indication may be a scrollable list of available construction materials within a certain distance and may include one or more images or videos. Access to the electronic platform may be granted for a monthly fee or subscription.

At block 130 of the process flow, an indication of user interest in the first construction material may be determined from a second user via a second user device of the plurality of devices. For example, computer-executable instructions of one or more modules at a remote server may be executed to receive an indication or determine an indication of interest in the first construction material from a second user device. In one example, the second user may be viewing the electronic platform and may select or otherwise indicate interest in acquiring the first construction material. The one or more servers may receive the indication of interest from the second user device.

At block 140 of the process flow, a confirmation message may be sent to the first user device. For example, computer-executable instructions of one or more modules at a remote server may be executed to send a confirmation message to the first user device. For example, the second user may agree to collect the first construction material before any applicable deadline from the first location. The one or more servers may send the confirmation message indicating that the second user has agreed to take the first construction material from the first location to either or both the first user device and/or the second user device. In some embodiments, the second user may agree to take a portion of the first construction material. In some embodiments, the second user may offer a certain price or bid for the first construction material in the event the first user requests a payment for the first construction material.

At block 150 of the process flow, a request for assistance with the first construction material may be received from the second user device. For example, computer-executable instructions of one or more modules at a remote server may be executed to receive a request for assistance with the first construction material from the second user device. For example, the second user may desire the first construction material but may not have a truck, labor, or other equipment that may be needed to transport the first construction material. The second user may input a selection or request indicating that assistance is needed for the first construction material.

At optional block 160 of the process flow, delivery of an assistance tool at the first location may be caused. For example, computer-executable instructions of one or more modules at a remote server may be executed to cause delivery of an assistance tool at the first location. Assistance tools may include any type of construction tool, such as Bobcats, lifts, tools, wraps, etc., and may include human labor, vehicles, such as trucks, and so forth. The second user may indicate that assistance is needed for loading or transport of the construction materials. For example, the second user may have a vehicle, but may need assistance with loading or unloading. In another example, the second user may not have a vehicle, but may have labor. In another example, the second user may need both vehicles and labor.

The remote server may receive the indication that assistance is needed and may facilitate the required assistance. For example, if only labor is needed, the remote server may send a request to the first user to determine whether the first user would be able to assist with loading the first construction material. The first user may indicate interest, as well as a price for the assistance. In another example, the remote server may send a request for assistance to one or more third parties that may be available to assist. For example, a transportation service provider may be sent a request for assistance and may accept or decline the request. In some embodiments, an auction process may be used to identify the party that is willing to provide assistance at the lowest cost. The second user may then select from among the parties or bids to determine an assistance provider.

At optional block 170 of the process flow, a penalty value may be determined to assign to the second user if the first construction material is present at the first location after an expiration time. For example, computer-executable instructions of one or more modules at a remote server may be executed to determine a penalty value to assign to the second user if the first construction material is present at the first location after an expiration time. The first user may indicate a deadline or expiration time at which the first construction material is to be removed from the first location. If the first construction material is present at the first location after the second user has agreed to remove the first construction material, a penalty, such as a financial penalty, may be assigned to the second user. The second user may accept the penalty value prior to accepting to remove the first construction material. In this manner, the first user may be compensated if the second user fails to remove the first construction material.

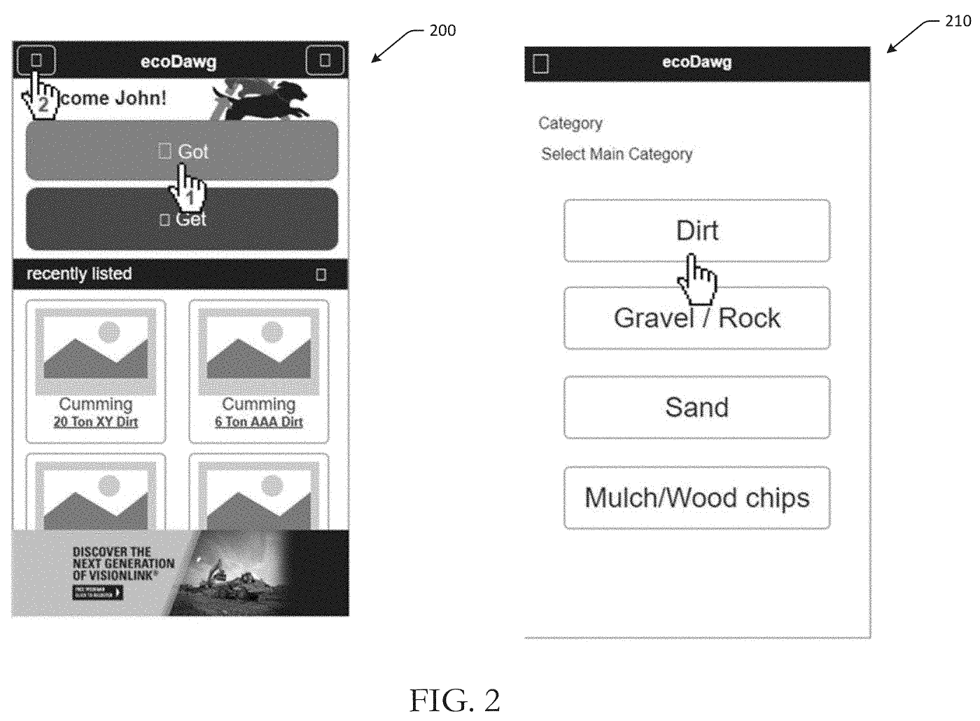

FIGS. 2-5 schematically illustrate example user interfaces for indicating availability of construction materials in accordance with one or more embodiments of the disclosure.

In FIG. 2, a first user interface 200 illustrates an example interface allowing a user to indicate whether construction material is available (“got”) or desired (“get”). The first user interface 200 may include recently listed construction materials that are available within a distance of the user device at which the first user interface 200 is presented. The user may select the “got” option indicating that the user has construction material available.

A second user interface 210 may provide selectable options of different categories of construction materials. For example, categories may include dirt, gravel/rock, sand, mulch/wood chips, and so forth. The user may select the applicable category, such as dirt.

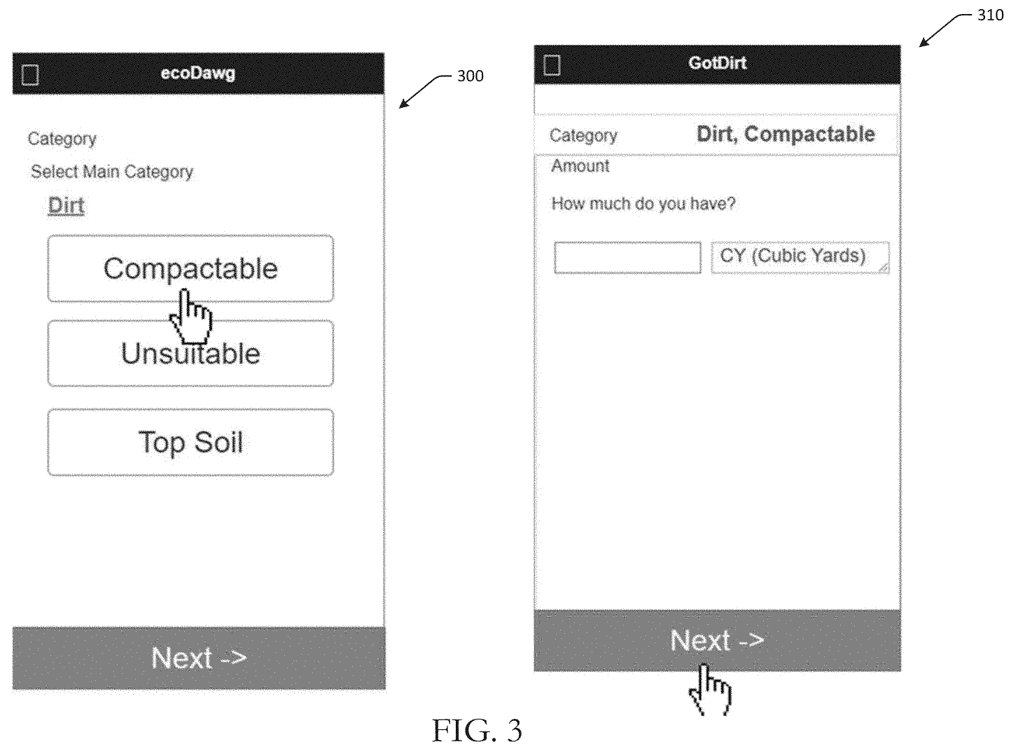

In FIG. 3, at a third user interface 300, the user may select a subcategory of the available construction material, such as compactable dirt, unsuitable dirt, top soil, and so forth. The user may select compactable.

At a fourth user interface 310, an input may be provided to enter an amount of construction material available. For example, an amount of compactable dirt may be input in suitable units, such as cubic yards, pounds, tons, and so forth. In some embodiments, an amount may be automatically determined using one or more images or video uploaded to the remote server.

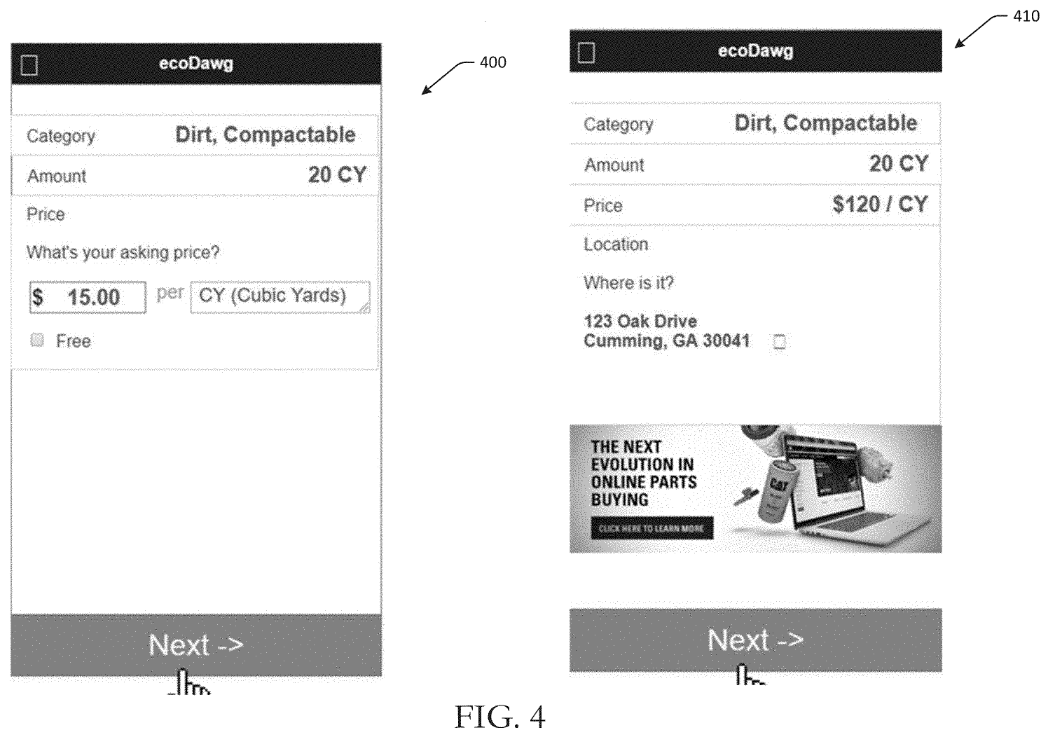

In FIG. 4, at a fifth user interface 400, the user may optionally input a price or cost of the construction material. For example, the user may indicate a price per unit, a flat fee, and so forth.

At a sixth user interface 410, the user may input the location of the construction material. For example, the user may input an address. In some instances, the address may be automatically determined using a device location or image metadata.

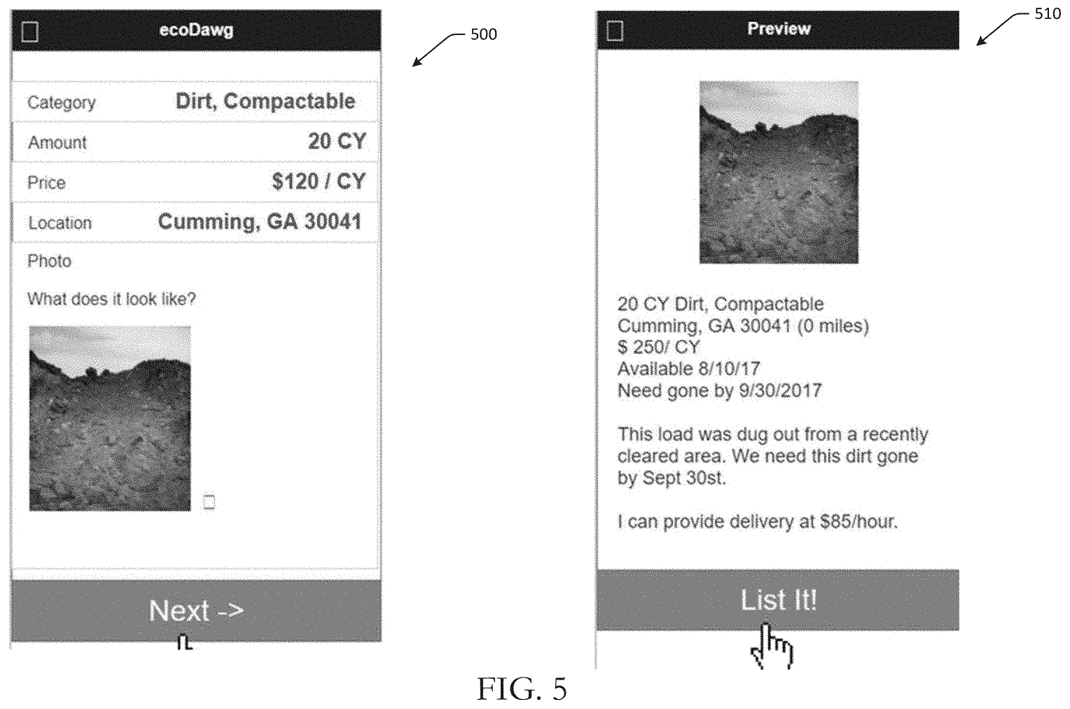

In FIG. 5, at a seventh user interface 500, the user may upload one or more images of the construction material. The images may be presented to other users that may be interested in the construction material.

At an eighth user interface 510, the user may input a date or time the construction material is available, a deadline or expiration time for when the construction material needs to be removed, information related to the construction material, and/or availability to assist with the removal of the construction material (e.g., I can provide delivery at $85/hour, etc.).

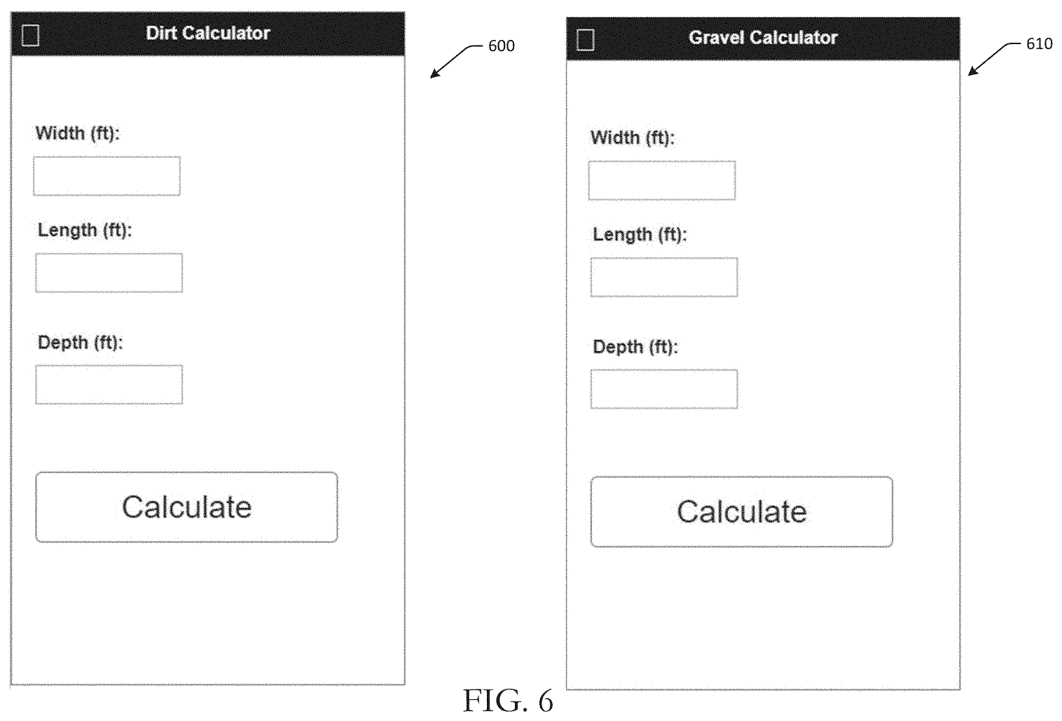

FIG. 6 schematically illustrates example user interfaces for calculating an amount of available construction material in accordance with one or more embodiments of the disclosure. For example, at a first user interface 600, a user may manually input a width, length, and/or depth of dirt and the one or more remote servers may automatically calculate an amount of dirt available. At a second user interface 610, a user may manually input a width, length, and/or depth of gravel and the one or more remote servers may automatically calculate an amount of gravel available.

In some embodiments, the user may not have to manually input values and may simply upload images or videos of the construction material, and the remote servers may automatically determine an amount using image processing algorithms.

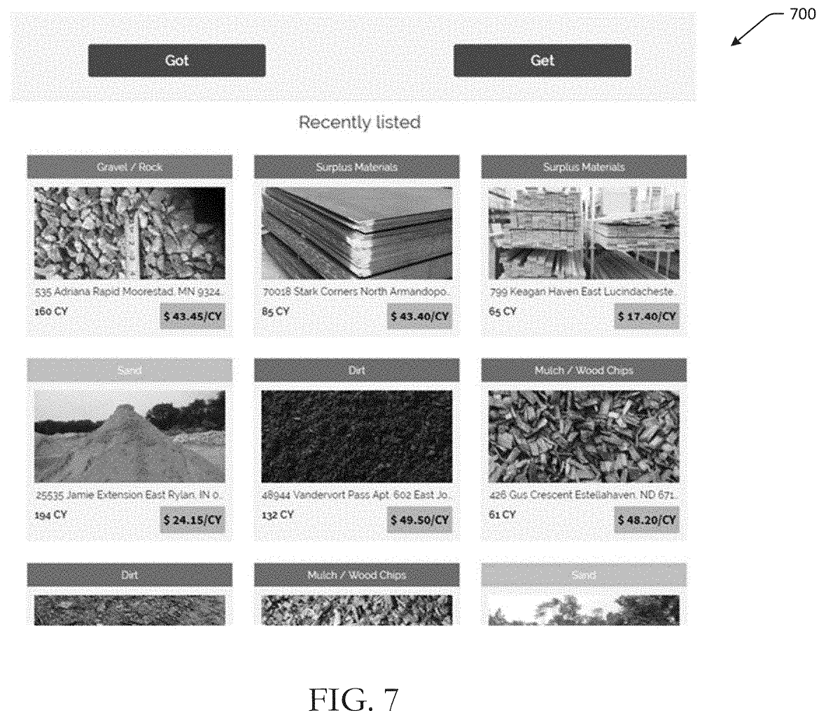

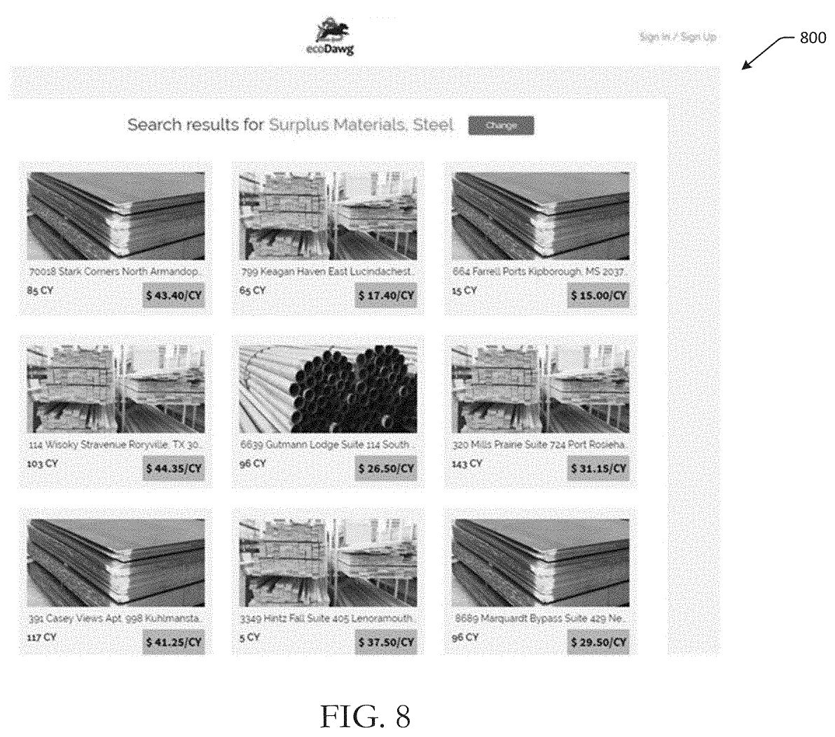

FIGS. 7-8 schematically illustrate example user interfaces for a construction material availability and transport platform in accordance with one or more embodiments of the disclosure.

FIG. 7 illustrates an example platform 700 with a number of construction materials available for other users to “get” or remove. The listings may be presented based at least in part on a threshold distance from a device at which the listings are presented. The user may input one or more search terms to find specific types of construction materials.

For example, at a search results interface 1200 in FIG. 8, the user may search for steel, and may be presented with the various available steel in the area. The user may select from the listings to acquire the desired amount of steel.

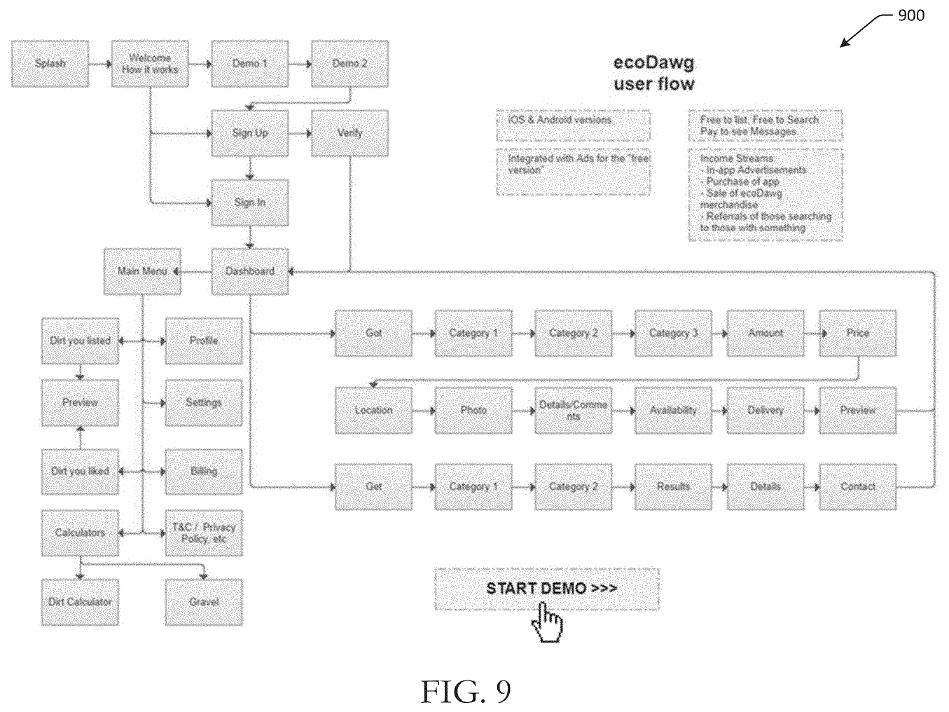

FIG. 9 is an example process flow diagram 900 for transport of construction materials in accordance with one or more embodiments of the disclosure. As illustrated in FIG. 9, an initial user experience may include a splash screen, followed by an intro and/or demo of the system. The user may sign up or subscribe and verify their email address and/or identity. When logged in, the user may be presented with a dashboard and/or main menu. The user may then list or acquire construction materials as desired.

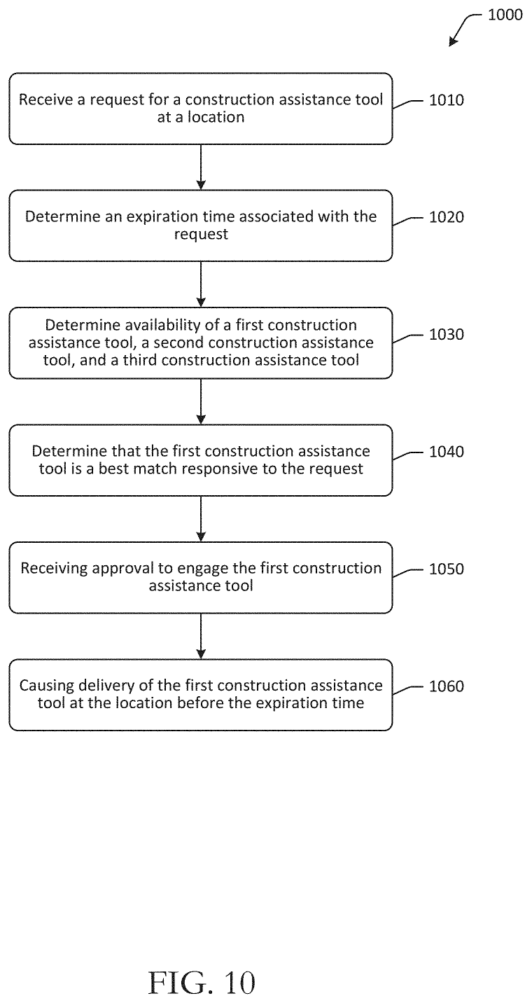

FIG. 10 is an example process flow diagram 1000 for locating and providing construction tools in accordance with one or more embodiments of the disclosure. The process flow may be performed by one or more remote servers, as described herein.

At block 1010, a request for a construction assistance tool at a location may be received. For example, a user may request a truck and 2 workers at a location.

At block 1020, an expiration time associated with the request may be determined. For example, the user may need the truck and 2 workers by 8 pm the same day.

At block 1030, availability of a first construction assistance tool, a second construction assistance tool, and a third construction assistance tool may be determined. For example, a first construction assistance tool of a first work crew including a truck and 2 workers may be available immediately, a second construction assistance tool of a second work crew including a truck and 1 worker may be available immediately, and a third construction assistance tool of a third work crew including a truck and 2 workers may be available the following day.

At block 1040, the first construction assistance tool may be determined to be a best match responsive to the request. The first construction assistance tool may be the best match because of availability, pricing, reviews, and/or other factors.

At block 1050, approval to engage the first construction assistance tool may be received. For example, a request to approve the first construction assistance tool may be sent to the requesting user and the user may approve the request.

At block 1060, delivery of the first construction assistance tool may be caused at the location before the expiration time. For example, the remote server may coordinate acceptance of the assistance request with the first construction assistance tool and the first construction assistance tool may be delivered to the location before the deadline. The construction material may be removed before the deadline as well.

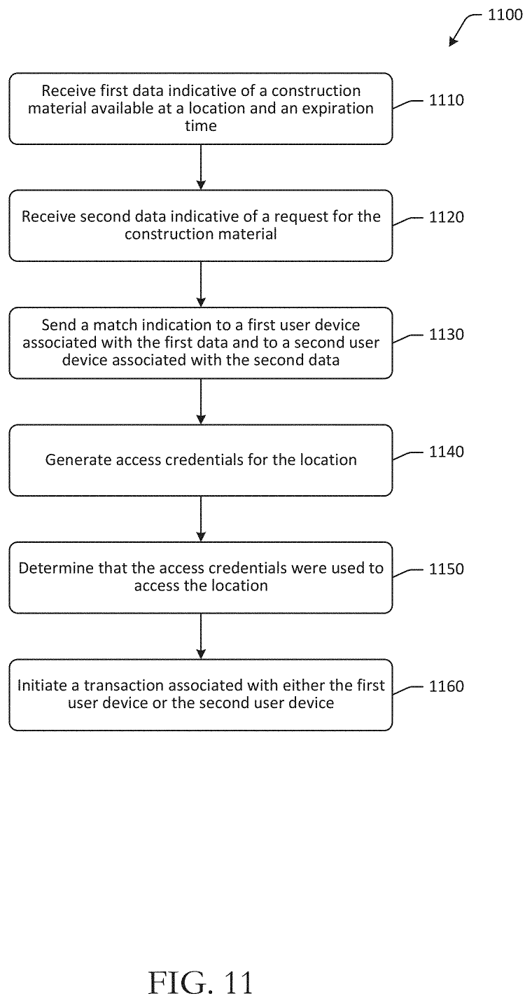

FIG. 11 is an example process flow diagram 1100 for authorizing access to various locations in accordance with one or more embodiments of the disclosure.

At block 1110, first data indicative of a construction material available at a location and an expiration time associated with the construction material may be received. For example, a user may post available construction material.

At block 1120, second data indication of a request for the construction material may be received. For example, a second user may be interested in the construction material.

At block 1130, a match indication may be sent to a first user device associated with the first data and to a second user device associated with the second data. The users may therefore be aware of the match.

At block 1140, access credentials for the location may be generated. The access credentials may be an authentication value and may be used by one or both parties to access the location or a drop off location and/or the construction materials.

At block 1150, it may be determined that the access credentials were used to access the location. For example, the requesting user may have accessed the location.

At block 1160, a transaction associated with either the first user device or the second user device may be initiated. For example, a payment may be made or facilitated after use of the access credentials.

One or more operations of the methods, process flows, or use cases of FIGS. 1-11 may have been described above as being performed by a user device, or more specifically, by one or more program module(s), applications, or the like executing on a device. It should be appreciated, however, that any of the operations of the methods, process flows, or use cases of FIGS. 1-11 may be performed, at least in part, in a distributed manner by one or more other devices, or more specifically, by one or more program module(s), applications, or the like executing on such devices. In addition, it should be appreciated that the processing performed in response to the execution of computer-executable instructions provided as part of an application, program module, or the like may be interchangeably described herein as being performed by the application or the program module itself or by a device on which the application, program module, or the like is executing. While the operations of the methods, process flows, or use cases of FIGS. 1-11 may be described in the context of the illustrative devices, it should be appreciated that such operations may be implemented in connection with numerous other device configurations.

The operations described and depicted in the illustrative methods, process flows, and use cases of FIGS. 1-11 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 1-11 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

### Illustrative Device Architecture

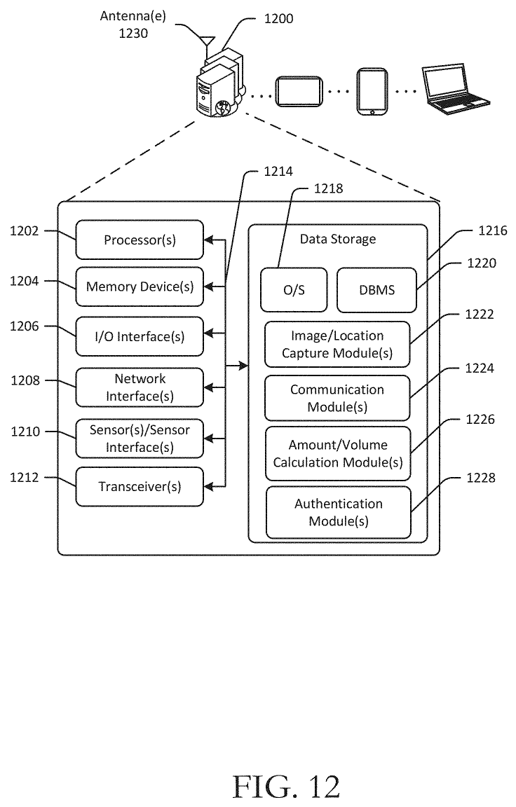

FIG. 12 is a schematic block diagram of an illustrative remote server 1200 in accordance with one or more example embodiments of the disclosure. The remote server 1200 may include any suitable computing device capable of receiving and/or generating data including, but not limited to, a mobile device such as a smartphone, tablet, e-reader, wearable device, or the like; a desktop computer; a laptop computer; a content streaming device; a set-top box; or the like. The remote server 1200 may correspond to an illustrative device configuration for the devices of FIGS. 1-11.

Example network(s) may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, such network(s) may have any suitable communication range associated therewith and may include, for example, global networks (e.g., the Internet), metropolitan area networks (MANs), wide area networks (WANs), local area networks (LANs), or personal area networks (PANs). In addition, such network(s) may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the remote server 1200 may include one or more processors (processor(s)) 1202, one or more memory devices 1204 (generically referred to herein as memory 1204), one or more input/output (I/O) interface(s) 1206, one or more network interface(s) 1208, one or more sensors or sensor interface(s) 1210, one or more transceivers 1212, and data storage 1216. The remote server 1200 may further include one or more buses 1214 that functionally couple various components of the remote server 1200. The remote server 1200 may further include one or more antenna(e) 1230 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth. These various components will be described in more detail hereinafter.

The data storage 1216 may include removable storage and/or non-removable storage including, but not limited to, magnetic storage, optical disk storage, and/or tape storage. The data storage 1216 may provide non-volatile storage of computer-executable instructions and other data. The memory 1204 and the data storage 1216, removable and/or non-removable, are examples of computer-readable storage media (CRSM) as that term is used herein.

More specifically, the data storage 1216 may store one or more operating systems (O/S) 1218; one or more database management systems (DBMS) 1220; and one or more program module(s), applications, engines, computer-executable code, scripts, or the like such as, for example, one or more image/location capture module(s) 1222, one or more communication module(s) 1224, one or more amount/volume calculation module(s) 1226, and/or one or more authentication module(s) 1228. Some or all of these module(s) may be sub-module(s). Any of the components depicted as being stored in data storage 1216 may include any combination of software, firmware, and/or hardware. The software and/or firmware may include computer-executable code, instructions, or the like that may be loaded into the memory 1204 for execution by one or more of the processor(s) 1202. Any of the components depicted as being stored in data storage 1216 may support functionality described in reference to correspondingly named components earlier in this disclosure.

The processor(s) 1202 may be configured to access the memory 1204 and execute computer-executable instructions loaded therein. For example, the processor(s) 1202 may be configured to execute computer-executable instructions of the various program module(s), applications, engines, or the like of the remote server 1200 to cause or facilitate various operations to be performed in accordance with one or more embodiments of the disclosure. The processor(s) 1202 may include any suitable processing unit capable of accepting data as input, processing the input data in accordance with stored computer-executable instructions, and generating output data. The processor(s) 1202 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 1202 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 1202 may be capable of supporting any of a variety of instruction sets.

Referring now to functionality supported by the various program module(s) depicted in FIG. 12, the image/location capture module(s) 1222 may include computer-executable instructions, code, or the like that responsive to execution by one or more of the processor(s) 1202 may perform functions including, but not limited to, determining device location, extracting metadata, extracting images from videos, and the like.

The communication module(s) 1224 may include computer-executable instructions, code, or the like that responsive to execution by one or more of the processor(s) 1202 may perform functions including, but not limited to, communicating with one or more devices, for example, via wired or wireless communication, communicating with remote servers, communicating with remote datastores, sending or receiving notifications or alerts, communicating with cache memory data, and the like.

The amount/volume calculation module(s) 1226 may include computer-executable instructions, code, or the like that responsive to execution by one or more of the processor(s) 1202 may perform functions including, but not limited to, processing images, applying pattern recognition algorithms to images, identifying construction materials, determining volumes, determining amounts, and the like.

The authentication module(s) 1228 may include computer-executable instructions, code, or the like that responsive to execution by one or more of the processor(s) 1202 may perform functions including, but not limited to, generating authentication values, determining whether access credentials were used, tracking use of credentials, and the like.

Referring now to other illustrative components depicted as being stored in the data storage 1216, the O/S 1218 may be loaded from the data storage 1216 into the memory 1204 and may provide an interface between other application software executing on the remote server 1200 and hardware resources of the remote server 1200. More specifically, the O/S 1218 may include a set of computer-executable instructions for managing hardware resources of the remote server 1200 and for providing common services to other application programs (e.g., managing memory allocation among various application programs). In certain example embodiments, the O/S 1218 may control execution of the other program module(s) to dynamically enhance characters for content rendering. The O/S 1218 may include any operating system now known or which may be developed in the future including, but not limited to, any server operating system, any mainframe operating system, or any other proprietary or non-proprietary operating system.

The DBMS 1220 may be loaded into the memory 1004 and may support functionality for accessing, retrieving, storing, and/or manipulating data stored in the memory 1204 and/or data stored in the data storage 1216.

Referring now to other illustrative components of the remote server 1200, the input/output (I/O) interface(s) 1206 may facilitate the receipt of input information by the remote server 1200 from one or more I/O devices as well as the output of information from the remote server 1200 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the remote server 1200 or may be separate. The I/O devices may further include, for example, any number of peripheral devices such as data storage devices, printing devices, and so forth.

The antenna(e) 1230 may include any suitable type of antenna depending, for example, on the communications protocols used to transmit or receive signals via the antenna(e) 1230. Non-limiting examples of suitable antennas may include directional antennas, non-directional antennas, dipole antennas, folded dipole antennas, patch antennas, multiple-input multiple-output (MIMO) antennas, or the like. The antenna(e) 1230 may be communicatively coupled to one or more transceivers 1212 or radio components to which or from which signals may be transmitted or received.

It should be appreciated that the program module(s), applications, computer-executable instructions, code, or the like depicted in FIG. 12 as being stored in the data storage 1216 are merely illustrative and not exhaustive and that processing described as being supported by any particular module may alternatively be distributed across multiple module(s) or performed by a different module. In addition, various program module(s), script(s), plug-in(s), Application Programming Interface(s) (API(s)), or any other suitable computer-executable code hosted locally on the remote server 1200, and/or hosted on other computing device(s) accessible via one or more networks, may be provided to support functionality provided by the program module(s), applications, or computer-executable code depicted in FIG. 12 and/or additional or alternate functionality. Further, functionality may be modularized differently such that processing described as being supported collectively by the collection of program module(s) depicted in FIG. 12 may be performed by a fewer or greater number of module(s), or functionality described as being supported by any particular module may be supported, at least in part, by another module. In addition, program module(s) that support the functionality described herein may form part of one or more applications executable across any number of systems or devices in accordance with any suitable computing model such as, for example, a client-server model, a peer-to-peer model, and so forth. In addition, any of the functionality described as being supported by any of the program module(s) depicted in FIG. 12 may be implemented, at least partially, in hardware and/or firmware across any number of devices.

It should further be appreciated that the remote server 1200 may include alternate and/or additional hardware, software, or firmware components beyond those described or depicted without departing from the scope of the disclosure. More particularly, it should be appreciated that software, firmware, or hardware components depicted as forming part of the remote server 1200 are merely illustrative and that some components may not be present or additional components may be provided in various embodiments. While various illustrative program module(s) have been depicted and described as software module(s) stored in data storage 1216, it should be appreciated that functionality described as being supported by the program module(s) may be enabled by any combination of hardware, software, and/or firmware. It should further be appreciated that each of the above-mentioned module(s) may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other module(s). Further, one or more depicted module(s) may not be present in certain embodiments, while in other embodiments, additional module(s) not depicted may be present and may support at least a portion of the described functionality and/or additional functionality. Moreover, while certain module(s) may be depicted and described as sub-module(s) of another module, in certain embodiments, such module(s) may be provided as independent module(s) or as sub-module(s) of other module(s).

Program module(s), applications, or the like disclosed herein may include one or more software components including, for example, software objects, methods, data structures, or the like. Each such software component may include computer-executable instructions that, responsive to execution, cause at least a portion of the functionality described herein (e.g., one or more operations of the illustrative methods described herein) to be performed.

A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform.

Another example programming language may be a higher-level programming language that may be portable across multiple architectures. A software component comprising higher-level programming language instructions may require conversion to an intermediate representation by an interpreter or a compiler prior to execution.

A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

Software components may invoke or be invoked by other software components through any of a wide variety of mechanisms. Invoked or invoking software components may comprise other custom-developed application software, operating system functionality (e.g., device drivers, data storage (e.g., file management) routines, other common routines and services, etc.), or third-party software components (e.g., middleware, encryption, or other security software, database management software, file transfer or other network communication software, mathematical or statistical software, image processing software, and format translation software).

Software components associated with a particular solution or system may reside and be executed on a single platform or may be distributed across multiple platforms. The multiple platforms may be associated with more than one hardware vendor, underlying chip technology, or operating system. Furthermore, software components associated with a particular solution or system may be initially written in one or more programming languages, but may invoke software components written in another programming language.

Computer-executable program instructions may be loaded onto a special-purpose computer or other particular machine, a processor, or other programmable data processing apparatus to produce a particular machine, such that execution of the instructions on the computer, processor, or other programmable data processing apparatus causes one or more functions or operations specified in the flow diagrams to be performed. These computer program instructions may also be stored in a computer-readable storage medium (CRSM) that upon execution may direct a computer or other programmable data processing apparatus to function in a particular manner, such that the instructions stored in the computer-readable storage medium produce an article of manufacture including instruction means that implement one or more functions or operations specified in the flow diagrams. The computer program instructions may also be loaded onto a computer or other programmable data processing apparatus to cause a series of operational elements or steps to be performed on the computer or other programmable apparatus to produce a computer-implemented process.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A method comprising:
determining, by one or more computer processors coupled to at least one memory, a first location of a construction material;
identifying the construction material using at least one image of the construction material;
determining an amount of the construction material using the at least one image;
determining a user identifier of a user interested in the construction material;
determining a second location associated with the user identifier;
determining a construction service provider identifier for a construction service provider for transport of the construction material from the first location to the second location; and
providing an authentication value to the construction service provider for accessing the first location or the second location.

2. The method of claim 1, further comprising:
determining that the construction material has been transported; and
facilitating transfer of an electronic currency from a user account associated with the user identifier.

3. The method of claim 1, further comprising:
performing an auction to determine the construction service provider.

4. The method of claim 1, wherein the authentication value is a machine readable image, a code, a passphrase, or a graphic.

5. The method of claim 1, further comprising:
determining that the second location is within a threshold distance of the first location.

6. The method of claim 1, further comprising:
receiving the at least one image of the construction material.

7. The method of claim 1, further comprising:
determining an expiration time associated with the construction material; and
sending the expiration time to a device associated with the construction service provider identifier, wherein the expiration time triggers a penalty.

8. A system comprising:
memory configured to store computer-executable instructions; and
at least one computer processor configured to access the memory and execute the computer-executable instructions to:
determine a first location of a construction material;
receive at least one image of the construction material;
identify the construction material using the at least one image;
determine an amount of the construction material using the at least one image;
determine a user identifier of a user interested in the construction material;
determine a second location associated with the user identifier;
determine a construction service provider identifier for a construction service provider for transport of the construction material from the first location to the second location; and
provide an authentication value to the construction service provider for accessing the first location or the second location.

9. The system of claim 8, wherein the at least one processor is further configured to access the memory and execute the computer-executable instructions to:
determine that the construction material has been transported; and
facilitate transfer of an electronic currency from a user account associated with the user identifier.

10. The system of claim 8, wherein the at least one processor is further configured to access the memory and execute the computer-executable instructions to:
perform an auction to determine the construction service provider.

11. The system of claim 8, wherein the authentication value is a machine readable image, a code, a passphrase, or a graphic.

12. The system of claim 8, wherein the at least one processor is further configured to access the memory and execute the computer-executable instructions to:
determine that the second location is within a threshold distance of the first location.

13. The system of claim 8, wherein the at least one processor is further configured to access the memory and execute the computer-executable instructions to:
receive the at least one image of the construction material.

14. The system of claim 8, wherein the at least one processor is further configured to access the memory and execute the computer-executable instructions to:
determine an expiration time associated with the construction material; and
send the expiration time to a device associated with the construction service provider identifier, wherein the expiration time triggers a penalty.

15. A method comprising:
receiving, by one or more computer processors coupled to at least one memory, first data indicative of a construction material available at a location and an expiration time;
receiving second data indicative of a request for the construction material;
sending a match indication to a first user device associated with the first data and to a second user device associated with the second data;
generating access credentials for the location;
determining that the access credentials were used to access the location; and
initiating a transaction associated with either the first user device or the second user device,

16. The method of claim 15, further comprising:
generating a posting on a construction material exchange platform for the construction material, the posting indicating the construction material is available for pickup.

17. The method of claim 15, further comprising:
determining a construction service provider identifier for a construction service provider for transport of the construction material.

18. The method of claim 15, further comprising:
receiving a request for a construction assistance tool at a location;
determining an expiration time associated with the request;
determining availability of a first construction assistance tool, a second construction assistance tool, and a third construction assistance tool;
determining that the first construction assistance tool is a best match responsive to the request;
receiving approval to engage the first construction assistance tool;
causing delivery of the first construction assistance tool at the location before the expiration time.

19. The method of claim 18, further comprising:
determining that the first construction assistance tool has been returned; and
causing a deposit to be refunded.

20. The method of claim 15, further comprising:
determining a type of the construction material.
